(19) United States
(12) Patent Application Publication
(10) Pub. No.: US 2025/0205528 A1
(43) Pub. Date: Jun. 26, 2025

(54) FIRE SUPPRESSION SYSTEM

(71) Applicant: VK PROPERTY GROUP PTY LTD, Red Hill (AU)

(72) Inventor: James Christopher HAKOS, Red Hill (AU)

(21) Appl. No.: 18/852,158

(22) PCT Filed: Mar. 28, 2023
(86) PCT No.: PCT/AU2023/050224

§ 371 Date: Sep. 27, 2024

Related U.S. Application Data
(60) Provisional application No. 63/420,686, filed on Oct. 31, 2022.
(60) Provisional application No. 63/420,685, filed on Oct. 31, 2022.
(60) Provisional application No. 63/345,442, filed on May 25, 2022.
(60) Provisional application No. 63/345,441, filed on May 25, 2022.
(60) Provisional application No. 63/324,636, filed on Mar. 29, 2022.
(60) Provisional application No. 63/324,625, filed on Mar. 28, 2022.

(30) Foreign Application Priority Data
Aug. 4, 2022 (AU) 2022902192

(51) Int. Cl. A62C 35/02; A62C 35/13; A62C 37/11; A62C 37/50

(52) U.S. Cl. CPC A62C 35/026; A62C 35/13; A62C 37/11; A62C 37/50

(57) ABSTRACT

The present invention resides in a fire suppression system comprising a vessel adapted to contain a fire suppression agent: at least one outlet in fluid communication with the vessel, wherein the outlet is adapted to release the fire suppression agent; and a smoke detector adapted to actuate the at least one outlet. The present invention addresses one or more of the issues of prior art fire suppression systems.

### FIELD OF THE INVENTION

The present invention relates to the field of fire suppression or extinguishing. Particularly, the present invention relates to the field of a fire suppression system.

### BACKGROUND TO THE INVENTION

Any reference to background art herein is not to be construed as an admission that such art constitutes common general knowledge in Australia or elsewhere.

Fires can cause significant damage within a small timeframe. In this regard, controlling or extinguishing a fire quickly is paramount to reducing the amount of damage and harm caused by a fire.

The National Fire Protection Association (NFPA) estimates that there is an average of 358,300 home-based fires per year. These fires alone are the cause of at least 92% of civilian fire deaths.

Fire extinguishing systems can be utilized to help extinguish or control a fire. Conventional systems typically consist of individual valve and nozzle combinations, with each valve controlled independently by a thermally fusible element. Only the nozzles exposed to the heat produced by a fire are activated, with independently controlled valves, rather than the entire system. As a result, water damage is prevented far from the fire.

However, a problem with fire extinguishing system is that a large amount of piping and cabling is required, and this can be an expensive and time-consuming installation process.

It would be advantageous to address one or more of the above issues and/or at least provide a commercial alternative to the consumer.

### SUMMARY OF THE INVENTION

In a first aspect, although it need not be the only or indeed the broadest form, the invention resides in a fire suppression system comprising:
a vessel adapted to contain a fire suppression agent;
at least one outlet in fluid communication with the vessel, wherein the outlet is adapted to release the fire suppression agent; and
a smoke detector adapted to actuate the at least one outlet.

In one embodiment, the fire suppression agent comprises one or more of dry chemical powder, water, expansion foam, CO₂ and/or inert gas.

In embodiments, the fire suppression system further comprises a pressure gauge adapted to indicate the pressure of the fire suppression agent and/or the pressure in the vessel.

In some embodiments, the fire suppression system further comprises a communication module. In embodiments, the communication module is in communication with the smoke detector. In an embodiment, the communication module is wired and/or wireless communication with the smoke detector. In an embodiment, the communication module is formed with the smoke detector.

In an embodiment, the communication module is in communication with a pressure monitoring device. In an embodiment, the communication module comprises the pressure monitoring device. In embodiments, the pressure monitoring device is a pressure switch. The pressure monitoring device suitably monitors the pressure of the surrounding environment. The pressure monitoring device monitors the pressure of the surrounding environment to determine whether a fire is present or imminent.

In one embodiment, the smoke detector is adapted to send a signal to the communication module when a fire is detected. In certain embodiments, the communication module is adapted to send a notification when a fire is detected. In an embodiment, the communication module is in wireless communication with one or more electronic devices. In some embodiments, the electronic device is a portable electronic device.

In a preferred embodiment, the fire suppression system is powered by mains power and/or one or more batteries. In this embodiment, the mains power connection is severed when the smoke detector detects a fire.

In embodiments, the outlet comprises a temperature actuated device. In an embodiment, the outlet comprises a sprinkler. In certain embodiments, the outlet comprises a pendent sprinkler. In embodiments, the outlet comprises a nozzle. In an embodiment, the outlet comprises an aeration nozzle.

In some embodiments, the fire suppression system further comprises a bracket adapted to secure the vessel to the wall or surface.

In an embodiment, the outlet further comprises a conduit adapted to convey the contents of the vessel to the outlet(s). In embodiments, the conduit(s) are rotatable relative to the vessel.

In one embodiment, the sprinkler and/or nozzle of the outlet is angled relative to the conduit. In one embodiment, the sprinkler and/or nozzle is angled at between about 1° and about 45°, between about 5° and about 40°, between about 10° and about 35°, between about 15° and about 25°, between about 20° and about 25°, between about 20° and about 22°, about 20° or about 22° relative to the plane of the conduit.

In a certain embodiment, the fire suppression system comprises a mount. In one embodiment, the mount is an elongate member. In embodiments, the vessel is rotatable relative to the mount.

In embodiments, the fire suppression system is a portable fire suppression system. In some embodiments, the fire suppression system further comprises a support. In an embodiment, the support comprises a leg connected to an engagement portion. In certain embodiments, the engagement portion is adapted to engage or abut a surface.

In embodiments, the fire suppression system further comprises one or more valves.

In an embodiment, the fire suppression system comprises one or more vessels in fluid communication with at least one adjacent vessel.

In some embodiments, the fire suppression system further comprises a heat sensor adapted to determine the temperature of the surrounding area. In an embodiment, heat sensor is in wired and/or wireless communication with the communication module.

In certain embodiments, the fire suppression system further comprises a refill inlet. In some embodiments, the refill inlet is adapted to refill the fire suppressant in the vessel.

In embodiments, the fire suppression system further comprises an alarm. In one embodiment, the alarm comprises a speaker and/or light.

In some embodiments, the fire suppression system is powered by mains power and/or battery. The fire suppression system is adapted to cut off mains power when a fire is detected.

In some embodiments, the fire suppression system further comprises a flame sensor adapted to monitor for the presence of a flame. The flame sensor is in wired and/or wireless communication with the communication module.

In embodiments, the fire suppression system further comprises a pressure pump. In embodiments, the pressure pump is in communication with the vessel. In embodiments, the pressure pump is adapted to apply pressure to the contents of the vessel.

In some embodiments, the fire suppression system further comprises lifting columns.

In an embodiment, the fire suppression system further comprises a camera. In embodiments, the camera is a thermal camera. In one embodiment, the camera is adapted to collect information regarding the temperature of the surroundings. In certain embodiments, the camera is provided with a telescopic arm and/or gimble. In an embodiment, the gimble connects the camera and the telescopic arm. The camera is in wired and/or wireless communication with the communication module.

In one embodiment, the fire suppression system further comprises a proximity sensor. In embodiments, the proximity sensor detects for movement in the proximity and deters vandalism and/or theft and/or wildlife.

In embodiments, the fire suppression system further comprises a frame. In embodiments, the fire suppression system further comprises an exhaust panel and/or exhaust fan.

In certain embodiments, the communication module is adapted to receive a number of parameters of the surrounding environment. In one embodiment, the communication module is adapted to utilize one or more of the number of parameters to determine the presence of a fire or an imminent fire. In an embodiment, the communication module is adapted to actuate the outlet.

In some embodiments, the fire suppression system is adapted to connect to other fire suppression systems.

The various features and embodiments of the present invention referred to in the individual sections above and in the description which follows apply, as appropriate, to other sections, mutatis mutandis. Consequently, features specified in one section may be combined with features specified in other sections as appropriate.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 shows an embodiment of the fire suppression system;

FIG. 2 shows another embodiment of the fire suppression system;

FIG. 3 shows a further embodiment of the fire suppression system;

FIG. 4 shows yet another embodiment of the fire suppression system

FIG. 5 shows an embodiment of the fire suppression system embedded in a ceiling;

FIG. 6 shows an embodiment of the fire suppression system mounted on a ceiling;

FIG. 7 shows an exploded view of an embodiment of the fire suppression system;

FIG. 7a shows an exploded view of another embodiment of a fire suppression system;

FIG. 8 shows an exploded view of an alternative embodiment of the fire suppression system;

FIG. 8a shows an exploded view of another embodiment of a fire suppression system;

FIG. 9 shows an embodiment of a fire suppression system;

FIG. 10 shows the fire suppression system of FIG. 9 with the cover removed;

FIG. 11 shows another embodiment of a fire suppression system; and

FIG. 12 shows an embodiment of the conduit.

### DETAILED DESCRIPTION OF THE INVENTION

Embodiments of the present invention reside primarily in fire suppression system. Accordingly, the system and apparatus have been illustrated in concise schematic form in the drawings, showing only those specific details that are necessary for understanding the embodiments of the present invention so as to not obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order.

Words such as “comprises” or “includes” are intended to define a non-exclusive inclusion, such that a system, method, article, or apparatus that comprises a list of elements does not include only those elements but may include other elements not expressly listed, including elements that are inherent to such a system, method, article, or apparatus.

As used herein, the term ‘about’ means the amount is nominally the number following the term ‘about’ but the actual amount may vary from this precise number to an unimportant degree.

The present invention is predicated on the finding that it is possible to distribute a fire suppression agent over a larger area. Furthermore, the present invention may also be actuated independently of mains power supply or cut off therefrom (discussed in more detail hereinafter).

In a first aspect, the invention resides in a fire suppression system comprising:
a vessel adapted to contain a fire suppression agent;
at least one outlet in fluid communication with the vessel, wherein the outlet is adapted to release the fire suppression agent; and
a smoke detector adapted to actuate the at least one outlet.

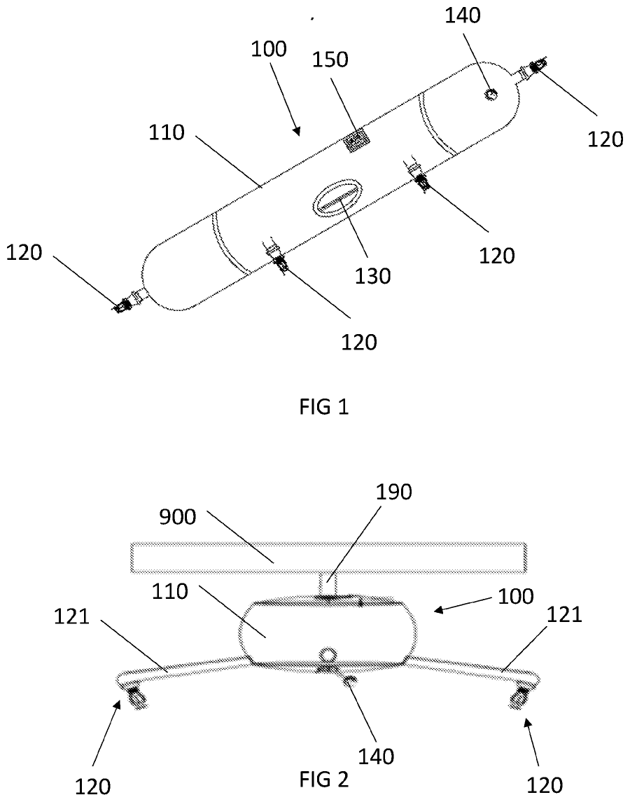

Shown in FIG. 1 is an embodiment of a fire suppression system. The fire suppression system 100 comprises a vessel 110 and outlets 120. The vessel 110 is adapted to contain a fire suppression agent. In an embodiment, the fire suppression agent is a pressurized fire suppression agent. The outlet 120 is in fluid communication with the vessel 110. The outlet 120 is adapted to release the fire suppression agent. The fire suppression system 100 further comprises a smoke detector 130 adapted to actuate the outlets 120. The smoke detector 130 is suitably affixed to the vessel 110. In an embodiment, the smoke detector 130 can be affixed to the vessel via a bracket.

In embodiments, the fire suppression agent comprises one or more of dry chemical powder, water, expansion foam, CO₂ and/or inert gas. In one embodiment, the inert gas is nitrogen. In one embodiment, the fire suppression agent comprises a mixture of water and at least 1% of fire retardant. In one embodiment, the fire suppression agent comprises a mixture of water and about 1% to about 3% of fire retardant. It will be appreciated that any fire suppression agent can be utilized and the above list is only some examples of the fire suppression agent that can be utilized in the present invention. In one embodiment, the fire suppression agent is pressurized. In an embodiment, the fire suppression agent is not pressurized.

The smoke detector 130 is adapted to detect smoke. When smoke is detected, the smoke detector 130 sends a signal to the outlets 120 to release the fire suppression agent from the vessel (either directly or via the communication module). It will be appreciated that the outlet 120 can either block fluid communication between the internal volume of the vessel and the external environment (when no fire is detected) or allow fluid communication between the internal volume of the vessel and the external environment (when a fire is detected). In one embodiment, the smoke detector is a smoke heat detector. As used herein, the term ‘smoke detector’ can be used interchangeably with ‘smoke heat detector’.

The fire suppression system 100 may further comprise a pressure gauge 140 adapted to indicate the pressure of the fire suppression agent. The pressure gauge provides a technician or a user with an indication of the pressure of fire suppression agent contained in the vessel. The user or technician can then refill the vessel with fire suppression agent as required. The vessel 110 of the present invention can be refilled with fire suppression agent.

The fire suppression system 100 may further comprise a communication module 150. The communication module 150 is suitably in communication with the smoke detector 130. In an embodiment, the communication module 150 is wired and/or wireless communication with the smoke detector 130. In an embodiment, the communication module 150 is formed with the smoke detector. The smoke detector 130 is adapted to send a signal to the communication module 150 when a fire is detected. The communication module 150 is suitably adapted to send a notification when a fire or other condition are detected. The communication module 150 is in wireless communication with one or more electronic devices. In some embodiments, the electronic device is a portable electronic device. In this regard, interested parties (such as the owner or tenants) of the premises may receive the notification. Furthermore, the emergency services (such as the fire department) may also receive the notification. This allows for the interested parties to have more time to get to safety. Furthermore, there is less delay in emergency services attending to the fire. In one embodiment, the communication device may send a SMS. In an embodiment, the communication device suitably connected to a wireless network. In an embodiment, the communication device is adapted to send a message to a service center.

It will be appreciated that the communication module 150 need not necessarily be in communication with the smoke detector 130. In an embodiment, the communication module 150 is in communication with a pressure monitoring device. In an embodiment, the communication module 150 comprises the pressure monitoring device. In embodiments, the pressure monitoring device is a pressure switch. The pressure monitoring device suitably monitors the pressure of the surrounding environment. The pressure monitoring device monitors the pressure of the surrounding environment to determine whether a fire is present or imminent. The pressure monitoring device is configured to send a signal if a predetermined pressure threshold is observed. When the predetermined pressure threshold is observed, the system is configured to send a signal. In an embodiment, the communication module sends the signal. In one embodiment, the predetermined pressure threshold is 200 PSI. In an embodiment, the communication module is adapted to actuate the outlet.

In an embodiment, the fire suppression system is powered by mains power. In some embodiments, the fire suppression system is powered by one or more batteries. In a preferred embodiment, the fire suppression system is powered by mains power and one or more batteries. In this embodiment, the mains power connection is severed when the smoke detector or pressure monitoring device detects a fire. In a further embodiment, the system may switch all mains power off. This prevents further issues relating to electricity and fire.

In one embodiment, the outlet comprises a temperature actuated device. In this regard, the temperature actuated device comprises a thermally-activated glass bulb that bursts when the temperature reaches a predetermined threshold. In an embodiment, the predetermined threshold is 68° C. However, it will be appreciated that the predetermined threshold can be any temperature. When the glass bulb bursts, the internal volume of the vessel is in fluid communication with the external environment and the contents of the vessel are released. In an embodiment, the fire suppression system releases at least 15 L of the fire suppression agent into a 780/550 ft² area.

Once activated, it is estimated that it only takes 5-20 seconds for the first suppression agent to react with the nearby flame and suppress it. This quick response alleviates the problem of the fire spreading and causing damage or further damage.

In an embodiment, the outlet comprises a sprinkler. In certain embodiments, the outlet comprises a pendent sprinkler. In embodiments, the outlet comprises an aeration nozzle.

In an embodiment, the fire suppression system is mounted or secured to a wall or surface. In some embodiments, the fire suppression system further comprises a bracket adapted to secure the vessel to the wall. It will be appreciated that the fire suppression system can suitably be directly secured or affixed to a wall or surface. In one embodiment, the fire suppression system may be embedded into a wall or surface.

It will be appreciated that the vessel can have any shape or dimensions. In this regard, the vessel may be in the shape of a cylinder (shown in FIG. 1). Alternatively, the vessel may be in the form of a cylindrical segment. In an embodiment, the cylindrical segment is about a quarter segment of a cylinder. The shape and dimension can be chosen based on the location of the fire suppression system. For instance, a cylinder-shaped vessel can be utilized in a ceiling or wall, whereas a quarter segment of a cylinder can be utilized in a corner (e.g., junction between a wall and ceiling). It will be appreciated that the above are only examples of some of the locations in which the fire suppression system can be utilized.

Shown in FIG. 2 is another embodiment of the fire suppression system. For the sake of brevity, the numbering system utilized for FIG. 1 has similarly been used for FIG. 2. Furthermore, the description of FIG. 1 is generally applicable to FIG. 2. The fire suppression system 100 comprises a vessel 110, outlets 120 and a smoke detector (not shown).

The main difference between the embodiment shown in FIG. 2 and FIG. 1 is the outlet 120 further comprise a conduit 121. As mentioned above, the outlet 121 comprises a sprinkler. In certain embodiments, the outlet comprises a pendent sprinkler. In embodiments, the outlet comprises an aeration nozzle. In this regard, the conduit connects the internal volume of the vessel to the sprinkler or nozzle. In an embodiment, the conduit is an elongate member. In certain embodiments, the elongate member is an annular member. In some embodiments, the elongate member is a tube.

In an embodiment, the conduits 121 are rotatable relative to the vessel 110. In this regard, a mechanism can be provided between the conduits 121 and the vessel 110 to facilitate rotation thereof. In this regard, the mechanism can suitably be a central ball bearing. In an embodiment, the conduits 121 and the outlets 120 are suitably freely rotatable relative to the vessel. In this regard, pressure created by expelling the fire suppression agent causes rotation of the conduits 121 (and thus outlets 121) and evenly spreads the fire suppression agent over an area. In an embodiment, the sprinkler and/or nozzle of the outlet is angled relative to the conduit. In one embodiment, the sprinkler and/or nozzle is angled at between about 1° and about 45°, between about 5° and about 40°, between about 10° and about 35°, between about 15° and about 25°, between about 20° and about 25°, between about 20° and about 22°, about 20° or about 22° relative to the plane of the conduit. As shown, the sprinkler and/or nozzle is angled inwardly by about 20°. It will be appreciated that the vessel can be sized to contain a predetermined amount of fire suppression agent. In this regard, it is preferably that the size of the vessel allows for it to be easily installed and transported. In this regard, in a preferred embodiment, the fire suppression agent is pressurized fire suppression agent to minimize the size of the vessel.

It will be appreciated that an external propellant can be utilized to assist in the rotation of the conduits 121 and outlet 120. In this regard, an example of a propellant is nitrogen. It will be appreciated that this also alleviates the requirement of electricity. The fire suppression agent will be spread to the maximum area during the fire, causing the initial extinguishing potential to be much higher. Furthermore, the area of coverage will be three times larger than a regular/conventional extinguisher.

In the embodiment shown in FIG. 2, the fire suppression system comprises three (3) outlets and conduits. In an embodiment, the outlets and conduits are evenly spaced. In the embodiment where three outlets and conduits are present, they are suitably spaced at about 120°. It will be appreciated that any number of outlets and conduits may be utilized. In this regard, the fire suppression system comprises 1, 2, 3, 4, 5, 6, 7, 8, 9 . . . outlets.

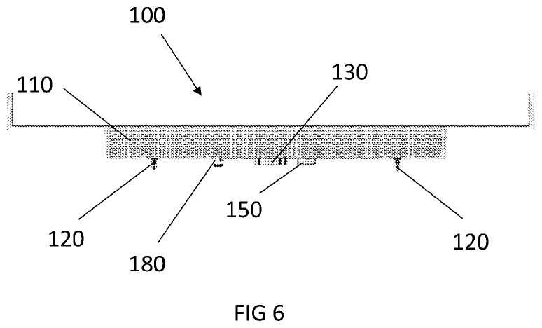

In the embodiment shown in FIG. 2, the fire suppression system 100 is suitably mounted to a ceiling 900. In this regard, the fire suppression system 100 is mounted to ceiling 900 by a mount. In the embodiment shown, the fire suppression system 100 is mounted to the ceiling 900 by an elongate member 190. In an embodiment, the elongate member 190 comprises a rod. It will be appreciated that the fire suppression system 100 may be suitably mounted into the ceiling such that only certain components thereof reside below the ceiling (as shown in FIG. 5). It will also be appreciated that the fire suppression system is mounted to a ceiling that the fire suppression system can mounted to a ceiling (as shown in FIG. 6)

In one embodiment, the vessel 110 may be rotatable relative to the elongate member 190. In this embodiment, the conduits 121 and outlets 120 need not necessarily be rotatable relative to the vessel 110. The rotation of the vessel 110, and thus conduits and outlets 120, relative to the elongate member 190 generally achieves the same result.

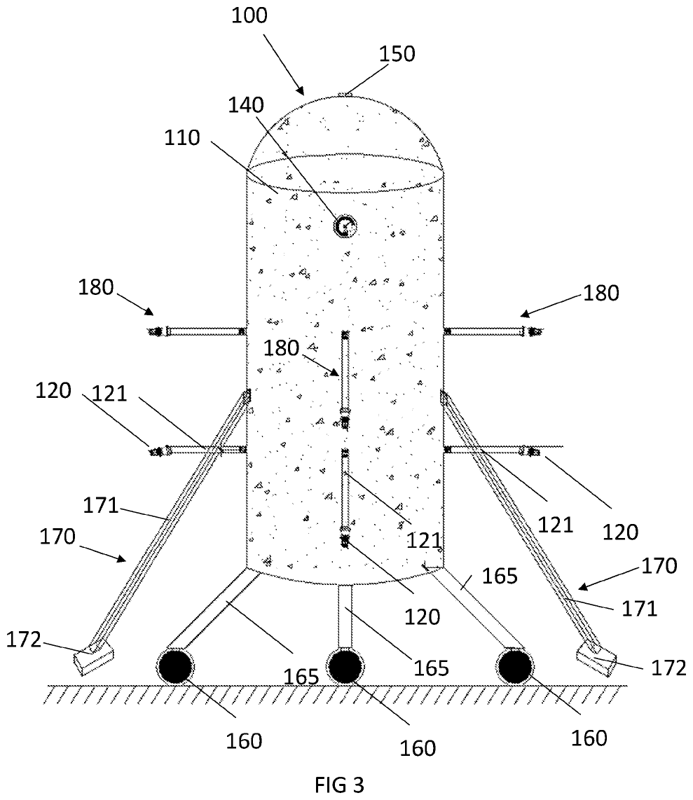

Shown in FIG. 3 is another embodiment of the fire suppression system. For the sake of brevity, the numbering system utilized for FIG. 3 has similarly been used for FIGS. 1 and 2. Furthermore, the description of FIGS. 1 and 2 is generally applicable to FIG. 3. The fire suppression system 100 comprises a vessel 110, outlets 120 and a smoke detector 140.

The main difference between the embodiment shown in FIG. 3 and those of FIGS. 1 and 2 is that the vessel is transportable. In this regard, the fire suppression system 100 is provided with one or more wheels adapted to facilitate movement thereof. In an embodiment, the fire suppression system 100 further comprises wheels 160. The fire suppression system 100 further comprises legs 165 connected to a respective wheel. The legs 165 and wheels 160 suitably raise the fire suppression system 100 from the ground.

In certain embodiments, the fire suppression system is a portable fire suppression system. In this embodiment, the fire suppression system is adapted to be moved to different locations. In embodiments, the fire suppression system comprises one or more wheels adapted to facilitate movement of the fire suppression system.

The fire suppression system 100 further comprises a support 170. The support 170 comprises a leg 171 connected to an engagement portion 172. The engagement portion 172 is adapted to engage or abut a surface to provide further stability to the fire suppression system 100. In one embodiment, the engagement portion 172 engages the ground.

The fire suppression system 100 further comprises a refill inlet 180. The refill inlet 180 is utilized to refill the fire suppressant in the vessel.

The fire suppression system 100 further comprises lights. In on embodiment, the lights are emergency lights 132. The emergency lights are adapted to turn on when a fire and/or emergency is detected.

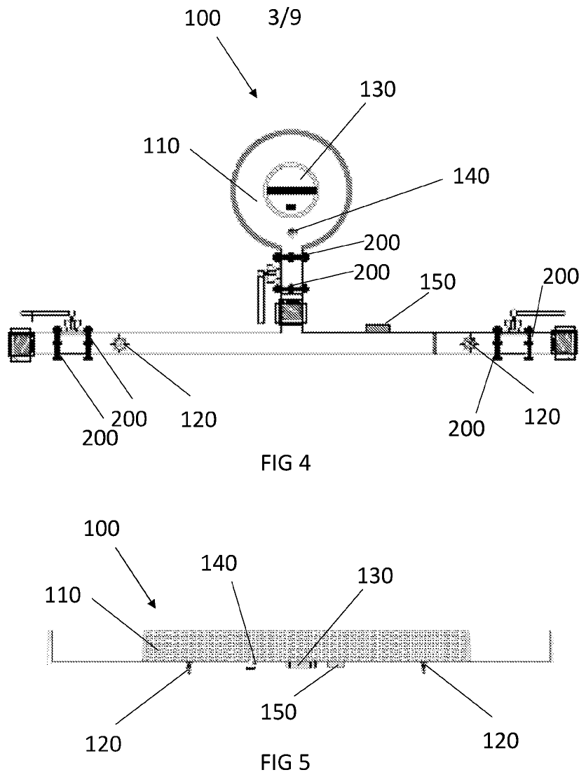

The main difference between the embodiment shown in FIG. 4 and those mentioned hereabove is the structure. In this regard, the present embodiment further comprises a number of valves 200 that are utilized to isolate certain parts of the system. In this regard, the provision of a valve between the vessel 110 and the outlets 120 allows isolation therebetween. Furthermore, the provision of valves 200 also provide an internal volume between the outlets 120 and the vessel 110. The provision of valves also allow for multiple fire suppression systems 100 to be connected to one another. In this regard, a number of fire suppression systems 100 can be utilized in series.

Shown in FIG. 7 is an exploded embodiment of the fire suppression system. For the sake of brevity, the numbering system utilized for FIG. 7 has similarly been used for FIGS. 1 to 6. Furthermore, the description of FIGS. 1 to 6 is generally applicable to FIG. 7. The fire suppression system 100 comprises a vessel 110, outlets 120, a smoke detector 130 and a communication module 150.

One of the differences between the embodiment shown in FIG. 7 and that of FIG. 1 is the provision of multiple vessels 110. In an embodiment, the fire suppression system 100 comprises a plurality of vessels 110. In the embodiment shown, the fire suppression system 100 comprises 8 vessels 110. Each vessel 110 is in fluid communication with at least one adjacent vessel through a conduit 111. The vessels are in fluid communication with an outlet 120. The outlet 120 suitably comprises a solenoid valve 122. In an embodiment, the outlet comprises a thermal expansion valve. In an embodiment, the outlet 120 suitably comprises a sprinkler or similar.

The fire suppression system 100 may further comprise a pressure gauge 140 adapted to indicate the pressure of the fire suppression agent. The pressure gauge provides a technician or a user with an indication of the pressure of fire suppression agent contained in the vessel. The user or technician can then refill the vessel with fire suppression agent as required. The vessel 110 of the present invention can be refilled with fire suppression agent.

The fire suppression system 100 further comprises a heat sensor 185 adapted to determine the temperature of the surrounding area. The heat sensor 185 is in wired and/or wireless communication with the communication module 150. The fire suppression system 100 may comprise one or more heat sensors. In the embodiment shown, the fire suppression system 100 comprises 3 heat sensors.

The fire suppression system 100 further comprises a refill inlet 180. The refill inlet 180 is utilized to refill the fire suppressant in the vessel.

The fire suppression system 100 further comprises a cover 190. The cover 190 provides an aesthetically pleasing façade. The cover 190 also provides protection for the components of the fire suppression system. The cover comprises a support grid 191 and outer shell 192.

The fire suppression system 100 further comprises an alarm 195. In an embodiment, the alarm comprises a speaker and/or light. The alarm and/or light adapted to activate when a fire is detected to alert people in the vicinity.

In one embodiment, the fire suppression system further comprises a battery. The battery provides a backup power supply to the fire suppression system.

The fire suppression system 100 is suitably provided with a flame sensor 131 adapted to monitor for the presence of a flame. The flame sensor 131 is in wired and/or wireless communication with the communication module 150. The flame sensor 131 is adapted to monitor the UV emission of the surrounding area for an indication of a flame. In a preferred embodiment, the flame sensor 131 is located nearby the smoke detector 130.

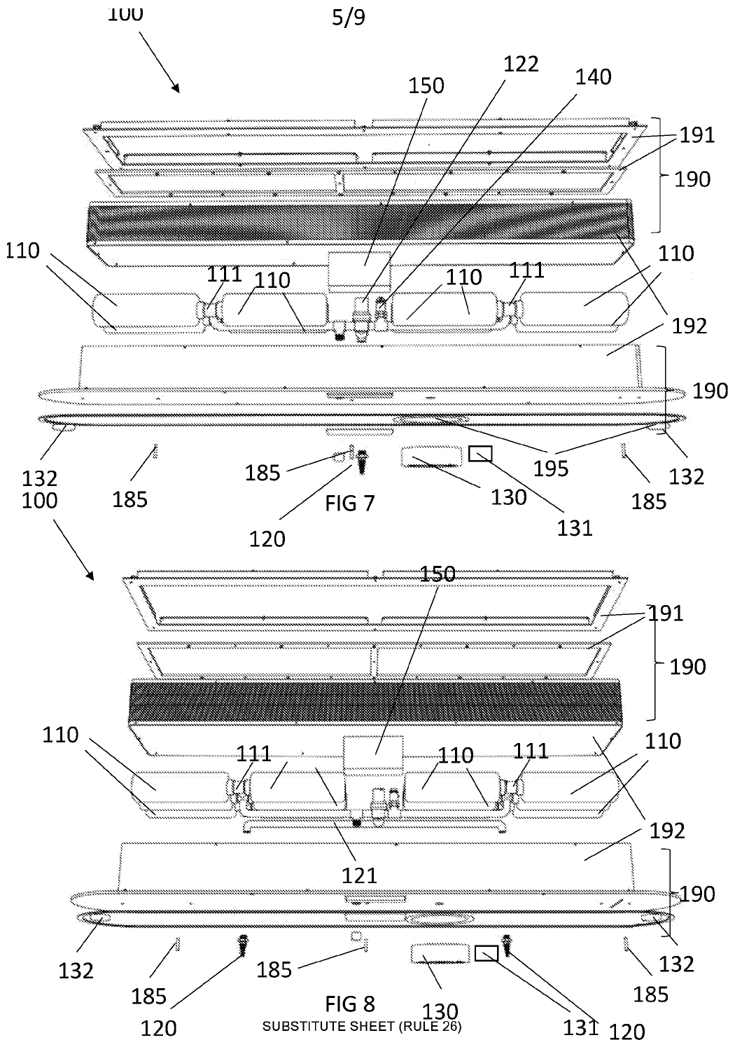

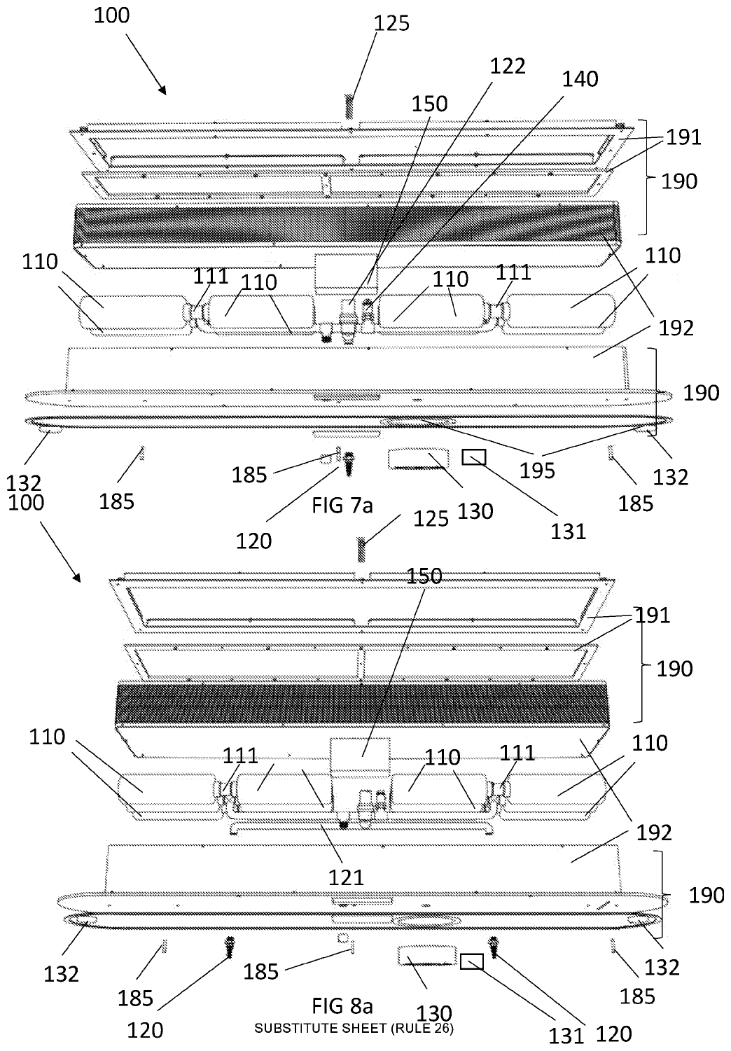

Shown in FIG. 8 is an exploded embodiment of the fire suppression system. For the sake of brevity, the numbering system utilized for FIG. 8 has similarly been used for FIGS. 1 to 7. Furthermore, the description of FIGS. 1 to 7 is generally applicable to FIG. 8. The fire suppression system 100 comprises a vessel 110, outlets 120, a smoke detector 130 and a communication module 150.

One of the differences between the fire suppression system of FIG. 8 and the fire suppression system of FIG. 7 is that the fire suppression system of FIG. 8 comprises 12 vessels. Each vessel 110 is in fluid communication with at least one adjacent vessel through a conduit 111. The vessels are in fluid communication with an outlet 120. The outlet 120 suitably comprises a solenoid valve 122.

The outlet 120 suitable comprises a conduit 121. The conduit connects the internal volume of the vessel 110 with the outlets 120. The conduit allows the contents of the vessel to be discharged through the outlets 120. In the embodiment shown in FIGS. 7 and 8, the outlet 120 suitably comprises a temperature actuated device or a controlled valve.

The fire suppression system 100 is suitably provided with a flame sensor adapted to monitor for the presence of a flame. The flame sensor is in wired and/or wireless communication with the communication module. The flame sensor is adapted to monitor the UV emission of the surrounding area for an indication of a flame. In a preferred embodiment, the flame sensor is located nearby the smoke detector.

The fire suppression system 100 is suitably provided with a flame sensor 131 adapted to monitor for the presence of a flame. The flame sensor 131 is in wired and/or wireless communication with the communication module 150. The flame sensor 131 is adapted to monitor the UV emission of the surrounding area for an indication of a flame. In a preferred embodiment, the flame sensor 131 is located nearby the smoke detector 130.

It will be appreciated that the present fire suppression system may be adapted to put out a fire in the room (e.g., under the fire suppression system), or even adapted to put out a fire in the ceiling. Shown in FIGS. 7a and 8a are embodiments of the fire suppression system. The embodiment shown in FIG. 7a is substantially similar to the embodiment shown in FIG. 7, and the embodiment shown in FIG. 8a is substantially similar to the embodiment shown in FIG. 8. For the sake of brevity, the number system utilized has been similarly used. The fire suppression system of FIGS. 7a and 8a comprise a ceiling outlet 125. The ceiling outlet is suitably adapted to protrude above the ceiling into, for example, the ceiling cavity. The ceiling outlet 125 is adapted to release the fire suppression agent into the ceiling to put out a fire or alleviate a fire therein. The ceiling outlet 125 suitably comprises a temperature actuated device. In an embodiment, the ceiling outlet 125 comprises a solenoid actuated device. In this regard, the temperature actuated device comprises a thermally-activated glass bulb that bursts when the temperature reaches a predetermined threshold. In an embodiment, the predetermined threshold is 68° C. In an embodiment, the predetermined threshold can also be a change in temperature. For instance, the predetermined threshold can be a rise in temperature of 10° C. outside of a normal ambient temperature increase. The ceiling outlet 125 comprises a pendant sprinkler.

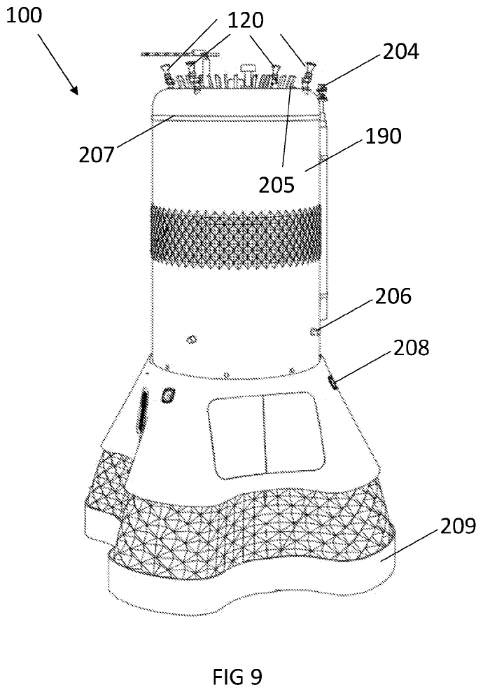

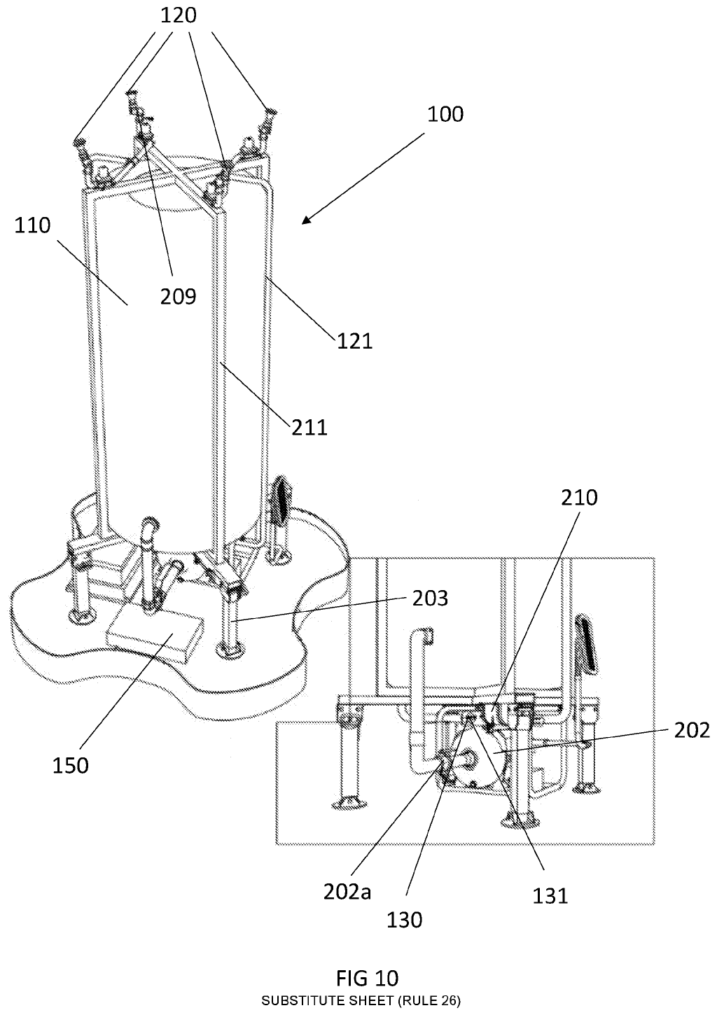

Shown in FIG. 9 is another embodiment of a fire suppression system, and shown in FIG. 10 is an exploded embodiment of the fire suppression system of FIG. 9. For the sake of brevity, the numbering system utilized for FIGS. 9 and 10 have similarly been used for FIGS. 1 to 8. Furthermore, the description of FIGS. 1 to 8 is generally applicable to FIGS. 9 and 10. The fire suppression system 100 comprises a vessel 110, outlets 120, a smoke detector 130 and a communication module 150.

The embodiment shown in FIGS. 9 and 10 is similar to that of FIG. 3. In this regard, the embodiment shown in FIGS. 9 and 10 is in the form a tower. The fire suppression system is further provided with conduits 121 between the tank 110 and the outlets 120.

In the embodiment shown, the fire suppression system 100 comprises four (4) outlets. Each outlet 120 may suitable directed in opposite directions. In an embodiment, the outlets may be positioned at 90 degrees from each other.

The fire suppression system 100 is suitably provided with a flame sensor 131 adapted to monitor for the presence of a flame. The flame sensor 131 is in wired and/or wireless communication with the communication module 150. The flame sensor 131 is adapted to monitor the UV emission of the surrounding area for an indication of a flame. In a preferred embodiment, the flame sensor 131 is located nearby the smoke detector 130.

In the embodiment shown, the fire suppression system comprises 4 flame sensors. Each flame sensor is located near a respective outlet. In an event of a fire, the flame sensor facing the specific position will activate the nozzle and this will result in 360 degree coverage. The flame detector may be adapted to detect a flame of at least 25 m or at least 35 m. In an embodiment, the outlet may suitably be a sprinkler that provides good coverage of fire suppression agent,

The fire suppression system 100 may further comprise a pressure pump. In an embodiment, the pressure pump is in fluid communication with the vessel to apply pressure to the contents of the vessel such that it exits through the outlets 120. In an embodiment, the pressure pump is a high pressure water pump 202. In one embodiment, the pressure pump is utilized in conjunction with a non-pressurized fire suppression agent.

The fire suppression system 100 further comprises one or more legs. In an embodiment, the one more legs are adapted to provide vertical movement to the fire suppression system. In one embodiment, the fire suppression system further comprises lifting columns 203. The lifting columns 203 provide the fire suppression system the ability to adjust the height thereof. In one embodiment, the fire suppression system 100 further comprises an accelerometer. The accelerometer is adapted to measure acceleration forces. The lifting columns adjust based on the information from the accelerometer and can adjust the legs such that the fire suppression system is balanced.

The fire suppression system further comprises a camera. In one embodiment, the camera is a thermal camera 204. The camera is adapted to collect information regarding the temperature of the surroundings. The camera is provided with a telescopic arm such that the camera height can be adjusted. The camera is also provided with a gimble between the camera and the telescopic arm to provide further rotation thereof. This allows the camera to obtain further surrounding information regarding the temperature.

The fire suppression system further comprises a temperature sensor 205 adapted to collect and/or monitor information regarding the temperature.

The temperature sensor 205 is suitably in wired and/or wireless communication with the communication module 150.

The fire suppression system may further comprise a bird deterrent. In one embodiment, the bird deterrent is spikes 205. The spikes prevent birds from landing on the fire suppression system.

The fire suppression system further comprises a proximity sensor 206. The proximity sensor 206 detects for movement in the proximity and deters vandalism and/or theft. Additionally, the proximity sensor may also detect wildlife nearby. The proximity sensor 206 is suitably in wired and/or wireless communication with the communication module 150.

The fires suppression system may further comprise a light emitting device 207 and/or speaker 208. The light emitting device 207 and/or speaker 208 can be utilized to deter vandalism and/or theft and/or wildlife coming into close proximity. Furthermore, the light emitting device 207 and/or speaker 208 can be utilized to provide warning of potentially hazardous conditions. The light emitting device 207 and/or speaker 208 is suitably in wired and/or wireless communication with the communication module 150.

The fire suppression system may further comprise a stable base 209. The stable base provides the fire suppression system 100 with sufficient stability such that the chance of toppling over is minimized. In one embodiment, the stable base comprises cement or suitably dense and heavy material to provide support thereto.

The fire suppression system may further comprise an antenna. In an embodiment, the antenna is or comprises an IRIDIUM antenna. In an embodiment, the antenna may comprises an extendable pole adapted to provide further height thereto for a signal. In an embodiment, the extendable pole is a telescopic member.

The fire suppression system may further comprise a water detector sensor 209. The water detector sensor is adapted to monitor for the presence of water. The water detector sensor acts as feedback for the nozzle and tank, and detects whether the nozzle has received water. In one embodiment, the water detector system is adapted to detect a leak inside the fire suppression system and/or detect if the fire suppression system has activated for any reason other than for a hazard. The water detector sensor 209 is suitably in wired and/or wireless communication with the communication module 150.

The fire suppression system may further comprise a fire extinguisher 210 attached thereto. The fire extinguisher 210 may be utilized by a user to assist in putting out a fire.

The fire suppression system may further comprise a frame 211. The frame 211 provides the fire suppression system with strength and structure.

The fire suppression system may further comprise an exhaust fan and/or duct to remove heat and/or dust from the internal volume of the fire suppression system.

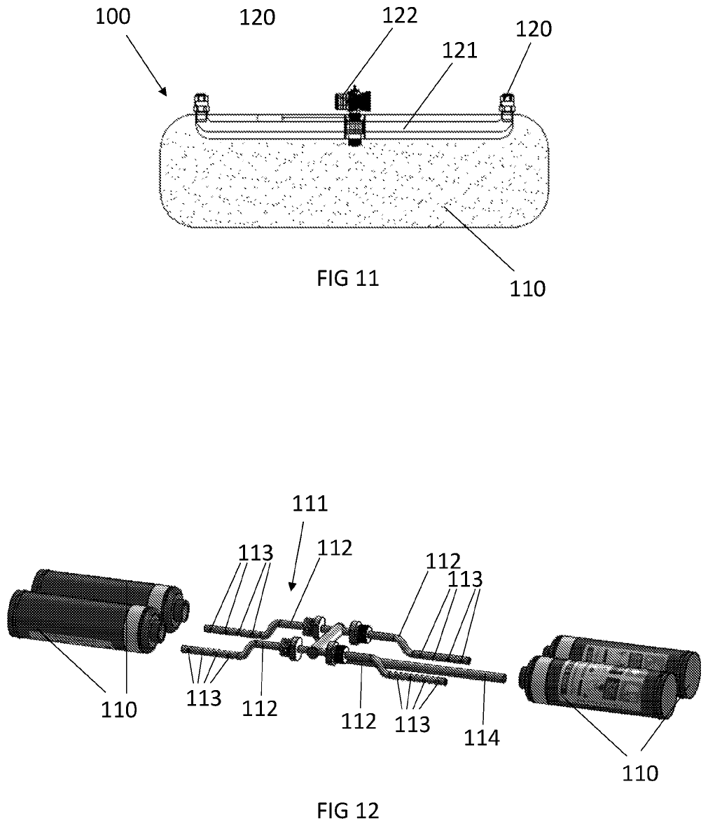

Shown in FIG. 11 is an embodiment of a fire suppression system. For the sake of brevity, the numbering system utilized for FIG. 11 has similarly been used for FIGS. 1 to 10. Furthermore, the description of FIGS. 1 to 10 is generally applicable to FIG. 11. The fire suppression system 100 comprises a vessel 110 and outlet 120. The fire suppression system 100 utilizes a conduit 121 to connect the vessel to the outlet 120. Furthermore, the fire suppression system 100 comprises a valve 122 adapted to open fluid communication between the contents of the vessel to the outlet. In an embodiment, the valve 122 is a thermal expansion valve. In an embodiment, outlet comprises a sprinkler or similar.

In the embodiment disclosed herein where multiple vessels are present, the conduit 111 are suitably adapted to extend substantially towards the bottom or closed end. In this regard, conduit 111 suitably comprises a tube that when connected to the vessel extends substantially the entire internal length thereof. In one embodiment, the tube are sized and adapted to face the bottom of the vessel. This conduit 111 suitably allows substantially all of the fire suppression agent in the vessels to be expelled during activation. It is postulated that the internal pressure of the fire suppression agent will pass through the tube. In one embodiment, the tube of the conduit 111 suitably comprises multiple apertures to allow the fire suppression agent therethrough. Furthermore, this conduit further allows all of the vessels to be filled simultaneously rather than separately.

Shown in FIG. 12 is an embodiment of the conduit 111, in the embodiment shown, the conduit 111 connects 4 vessels 110. However, it will be appreciated that the conduit can connect any number of vessels. The conduit comprises a tube 112 adapted to extends towards the bottom or base of the internal volume of the vessel 111. The tube 112 comprises multiple apertures 113 to allow the fire suppression agent therethrough. The conduit 111 is also adapted to form a fluid tight seal with the vessel 110. A manifold 114 may be utilized to connect multiple conduits 111.

In an embodiment, fire suppression system of FIG. 11 need not necessarily be connected to a power supply. This fire suppression system will automatically activate when the temperature reaches the predetermined temperature. Once the predetermined temperature is reached, the thermal expansion valve will release the fire suppression agent. In this embodiment, the fire suppression agent is pressurized. In one embodiment, the fire suppression agent comprises nitrogen as the propellant. In one embodiment, the predetermined temperature is 68° C. In a preferred embodiment, this fire suppression system essentially releases all of the fire suppression agent quick, In one embodiment, the fire suppression system releases essentially of the fire suppression agent within 10 seconds. In one embodiment, this vessel has a volume of about 0.25 L

The fire suppression system 100 can be sized such that it is compact to be utilized in confined environments. In one embodiment, the fire suppression system can be utilized in an automobile. In an embodiment, the automobile is a car.

The communication module is adapted to receive a number of parameters from the surrounding environment. The communication module is adapted to utilize one or more of these parameters to determine if a fire is present, or if there is a high likelihood of an imminent fire, in the surrounding area. In the event a fire is present or a high likelihood of an imminent fire then the fire suppression agent is released to alleviate or put out the fire.

It will be appreciated that the present fire suppression system provides a readily self-contained fire suppression agent that allows for the fire suppression system to be easily installed without the need to plumbing. Furthermore, the present fire suppression system (in some embodiments) can be transported to location and simply placed. This allows for a fire suppression system to be quickly and easily installed at the desired location.

The fire suppression system may be used in any venue, premises or business. Non-limiting examples of the locations where the present fire suppression system can be utilized include restaurants, bars, shops, homes, laboratories, hospitals, kitchens, gardens, bedrooms, offices and shops.

In some embodiments, the present invention can be utilized in the outdoor environment. The present invention can be placed in remote areas and monitors the environment for fires. The present invention can quickly detect fires, identify their location, extinguish them with fluid and then send alerts to the base station to dispatch emergency personnel. It will be appreciated that the present fire suppression systems can be utilized both indoors and outdoors depending on the embodiments. The communication module can send period updates to a server.

The fire suppression system may be attached to portable stands, or any other variations known in the art.

The fire suppression system may feature a disposable/collapsible covering for aesthetic reasons which do not inhibit the functions.

The fire suppression system may be integrated with smart technology in order to inform the user regarding the parameters or properties of the location of the fire suppression system. Non-limiting examples of the parameters or properties of the location include the temperature, humidity, voltage of battery temperature, smoke detector status and air pressure. The fire suppression system may periodically monitor the parameters of the location.

In an embodiment, the fire suppression system further comprises a GPS location module. The GPS location module is adapted to provide accurate position of the module and thus fire suppression system. This advantageously provides an accurate location of a possible fire.

In one embodiment, the fire suppression system has satellite network connectivity. The satellite network is a fail-safe method. In an embodiment, the fire suppression system also has LoRa network to send data.

The fire suppression system may use a wet pipe system, dry pipe system, deluge system, pre action system, foam water sprinkler system, water spray systems, water mist systems, or any other variations known in the art.

The fire suppression system may suitably be placed on a wall, on a ceiling, in the corner of a room.

In one embodiment, the vessel has an internal volume of between 0.25 L and about 1000 L, between about 5 L and 20 L, between about 8 L and about 12 L, between about 500 L and about 1000 L, about 0.25 L, about 8 L, about 12 L, about 500 L, about 750 L, or about 1000 L.

In one embodiment, the outlets are adjustable outlets such that direction and discharge of the fire suppression agent may be control and/or adjusted. This allows for the fire suppression agent to be directed towards the area or vicinity of a fire or imminent fire. The camera and sensors provide an indication of the vicinity of the fire or imminent fire.

In one embodiment, the fire suppression system is adapted to discharge the fire suppression agent between about 5 seconds and about 5 minutes, between about 5 seconds and about 2 minutes, between about 5 seconds and about 1 minute, between about 5 seconds and 25 seconds, between about 5 seconds and about 10 seconds, about 5 seconds, about 10 seconds, about 15 seconds, about 20 seconds or about 25 seconds.

The present fire suppression system provides an automatic response to a fire or imminent fire to alleviate the problems associated with fires. The present fire suppression system utilizes environment conditions to generate automatic actions based on detected parameters. These environmental conditions include heat, smoke, pressure and similar parameters. Furthermore, the fire suppression system is adapted to provide essentially 360° coverage such that the fire suppression agent can reach all areas of the coverage space and extinguish the fire effectively.

An advantage of utilizing smoke detectors and flame detectors is that they allow for the monitoring of both smoke and flame prior to activation. In one embodiment, the fire suppression system is adapted to activate only when smoke is detected and flame is detected. In one embodiment, the fire suppression system is adapted to activate only when smoke of a predetermined threshold is observed and a flame is observed This alleviates the problem of accidental discharge when the smoke detector is activated randomly. This prevents a false alarm from setting off the fire suppression system.

The communication module is in wireless and/or wired communication with any sensor of the fire suppression system. These parameters are suitably conveyed to interested parties (such as the fire department or monitor/headquarter) which allow them to promptly communicate with fire rescue. For instance, if smoke is detected but a flame is not, then the interested party may contact an entity close to or in the vicinity to ensure that there is no fire. Alternatively, if smoke and fire is detected then the fire station will be alerted for fire rescue.

In some embodiments, such as those in the outdoors environment, adjacent fire suppression systems may be activated to assist in putting out or alleviate the spread of a fire. The communication module can both send signals and also act on signals received from either other fire suppression systems or a user.

It will be appreciated that by the person skilled in the art that one or more of the above discussed sensors may be in the form of a multi-detection sensor. That is, the fire suppression system may suitably comprise one or more multi-detection sensors adapted to monitor one or more parameters. Non-limiting examples of the parameters that can be detected have been mentioned hereinabove. Non-limiting examples include smoke, heat, flame, pressure,

The subject-matter of U.S. provisional patent application Nos. 63/324,625, 63/324,636, 63/345,441 and 63/345,442 is incorporated herein in their entirety by reference. The subject-matter of Australian provisional patent application No. 2022902192 is incorporated herein its entirety by reference.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A fire suppression system comprising:
a vessel adapted to contain a fire suppression agent;
at least one outlet in fluid communication with the vessel, wherein the outlet is adapted to release the fire suppression agent;
a conduit adapted to convey the contents of the vessel to the outlet, wherein the conduit is adapted to connect to an adjacent conduit of another fire suppression system; and
a smoke detector and/or communication module adapted to actuate the at least one outlet,
wherein the conduit comprises one or more valves adapted to control fluid communication of the internal volume of the conduit with the adjacent conduit.

2. The fire suppression system of claim 1, further comprising a pressure gauge adapted to indicate the pressure of the fire suppression agent and/or the pressure in the vessel.

3. The fire suppression system of claim 1, wherein the communication module is configured for wired and/or wireless communication with the smoke detector.

4. The fire suppression system of claim 1, wherein the fire suppression system is powered by mains power and/or one or more batteries.

5. The fire suppression system of claim 1, wherein the outlet comprises a temperature actuated device, sprinkler, pendant sprinkler, nozzle and/or aeration nozzle.

6-7. (canceled)

8. The fire suppression system of claim 1, further comprising a heat sensor adapted to determine the temperature of the surrounding area.

9. The fire suppression system of claim 1, further comprising a refill inlet adapted to refill the vessel.

10. The fire suppression system of claim 1, further comprising a flame sensor adapted to monitor for the presence of a flame.

11. The fire suppression system of claim 1, further comprising lifting columns and/or legs.

12. The fire suppression system of claim 1, further comprising a camera.

13. The fire suppression system of claim 1, wherein the camera comprises a telescopic arm and/or gimble.

14. The fire suppression system of claim 1, wherein the communication module is adapted to receive a number of parameters of the surround environment.

15. The fire suppression system of claim 1, wherein the communication module is adapted to utilize one or more of the number of parameters to determine the presence of a fire or an imminent fire.
